(19) United States
(12) Patent Application Publication
(10) Pub. No.: US 2026/0219867 A1
(43) Pub. Date: Jul. 30, 2026

(54) OPTIMIZING PLATFORM PORTING PIPELINE FOR FIRMWARE DEPLOYMENT USING GENERATIVE AI

(71) Applicant: American Megatrends International, LLC, Duluth, GA (US)

(72) Inventors: Chitrak Gupta, Johns Creek, GA (US); Varadachari Sudan Ayanam, Suwanee, GA (US); Manoj Kumar P, Panruti (IN); Sriram Santhanam, Chennai (IN)

(21) Appl. No.: 19/039,287

(22) Filed: Jan. 28, 2025

(51) Int. Cl. G06F 8/65; G06F 8/76; G06F 9/54; G06F 11/07; G06F 21/57; G06F 40/20

(52) U.S. Cl. CPC G06F 8/65; G06F 8/76; G06F 9/54; G06F 11/0706; G06F 11/079; G06F 21/572; G06F 40/20

(57) ABSTRACT

In an aspect of the disclosure, a method, a computer-readable medium, and a system are provided. The apparatus may include one or more computing devices. The one or more computing devices analyze the natural language prompt using an artificial intelligence (AI) model to determine a sequence of firmware development operations. The one or more computing devices generate, through the AI model, a series of API calls corresponding to the determined sequence of firmware development operations. The one or more computing devices execute the series of API calls to perform the firmware development operations. The one or more computing devices generate a firmware image based on the executed series of API calls.

### BACKGROUND

### Field

The present disclosure relates generally to computer systems, and more particularly, to techniques of optimizing firmware development and deployment pipelines using artificial intelligence to automate platform porting, build orchestration, and testing through natural language processing of user prompts.

### Background

The statements in this section merely provide background information related to the present disclosure and may not constitute prior art.

Firmware development and deployment for computer systems such as servers may involve highly manual processes requiring significant developer intervention at multiple stages. Certain firmware development pipelines are rigid and sequential, where developers had to manually coordinate between different stages including source code management, platform-specific modifications, building firmware images, testing, and deployment. For example, when creating platform-specific firmware, developers needed to manually create sensor map files using specialized tools, implement extensions to core firmware code, define appropriate kernel configurations, and manage complex feature and library dependencies.

Certain build process may rely on fixed continuous integration/continuous deployment (CI/CD) pipelines that followed predetermined sequences of operations. While these pipelines provide some automation, they lack flexibility to dynamically adjust workflows based on changing requirements. Developers may need to manually trigger different pipeline stages, monitor build processes, analyze test results, and coordinate deployment activities. This rigid structure makes it difficult to parallelize operations or modify the sequence of steps without significant pipeline reconfiguration. Additionally, when issues occur during builds or deployments, developers need to manually analyze logs, identify root causes, and implement fixes through multiple iteration cycles.

This firmware development approach also faces challenges in managing the complexity of platform-specific customizations. Original Design Manufacturers (ODMs) and Original Equipment Manufacturers (OEMs) need to download firmware source code from providers, make various platform-specific modifications including adding custom patches and intellectual property packages, and ensure proper integration of all components. This process requires deep technical expertise and significant time investment to properly configure and validate firmware for each target platform. The manual nature of these operations increase the risk of human error and inconsistencies between different firmware builds.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a system are provided. The apparatus may include one or more computing devices. The one or more computing devices receive a natural language prompt requesting firmware development operations. The one or more computing devices analyze the natural language prompt using an artificial intelligence (AI) model to determine a sequence of firmware development operations. The one or more computing devices generate, through the AI model, a series of API calls corresponding to the determined sequence of firmware development operations. The one or more computing devices execute the series of API calls to perform the firmware development operations. The one or more computing devices generate a firmware image based on the executed series of API calls.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system that includes a baseboard management controller and a host computer.

FIG. 2 is a diagram illustrating a firmware development and deployment pipeline system that includes multiple firmware provider repositories and testing phases.

FIG. 3 is a diagram illustrating a cloud-enabled firmware development and deployment architecture that utilizes a cloud platform build orchestration service integrated with an AI model.

FIG. 4 is a diagram illustrating the interaction between an AI model and build services in the firmware development pipeline through simple build and code generation pathways.

FIG. 5 is a diagram illustrating an infrastructure management services architecture that incorporates artificial intelligence for firmware development pipeline optimization.

FIG. 6 is a flow chart of a method for performing firmware development operations using artificial intelligence through a sequence of operations from receiving prompts to generating firmware images.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

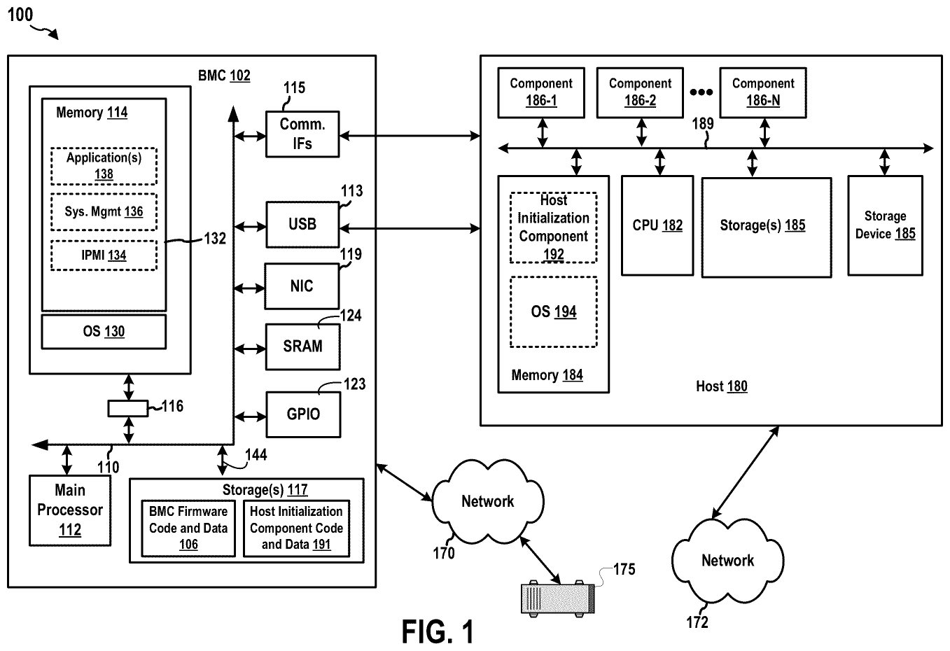

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface). The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

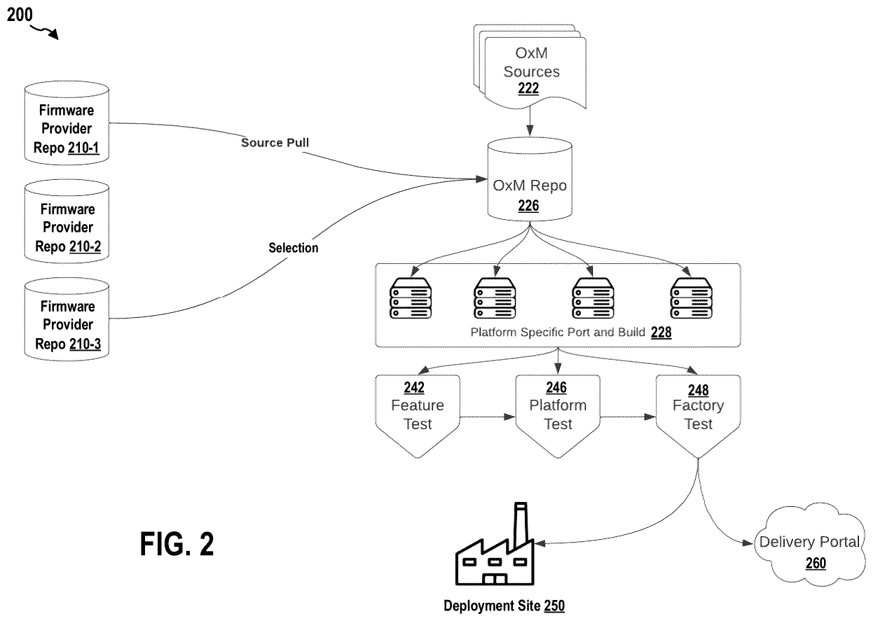

FIG. 2 is a diagram illustrating a firmware development and deployment pipeline system 200. The system 200 includes multiple firmware provider repositories 210-1, 210-2, and 210-3 that store firmware source code. The system also includes OxM sources 222 that contain platform-specific modifications and customizations.

These repositories may contain core code provided by a firmware provider as well as custom patches tailored to different platforms. An OxM repository 226 aggregates these sources, including OxM sources 222, and consolidates them into a unified base of firmware code.

The firmware provider repositories 210-1, 210-2, and 210-3 are connected to an OxM repository 226 through two different paths-a source pull path and a selection path. OxM may be Original Equipment Manufacturer (OEM) or Original Design Manufacturer (ODM). The source pull path enables direct transfer of firmware source code from the firmware provider repositories to the OxM repository 226. The selection path allows selective incorporation of specific code changes or patches from the firmware provider repositories into the OxM repository 226.

The OxM repository 226 can provide specific ports and builds 228 that has tailored firmware images, for each target system or platform, containing correct drivers, kernel-level configurations, and other necessary platform-dependent features.

The build process flows through three sequential testing phases: a feature test 242, a platform test 246, and a factory test 248. The feature test 242 validates individual firmware features and functionality. The platform test 246 performs comprehensive testing of the firmware on the target platform. The factory test 248 conducts final validation in a production environment. If the firmware image passes all test phases, it is distributed to a deployment site 250, which may represent a manufacturing location or a server rack in a data center. Further, the tested and approved firmware is also distributed to a delivery portal 260, thus completing the pipeline.

As illustrated in FIG. 2, the firmware provider provides a build orchestration system that enables customers to port firmware sources to their specific platforms. The system includes multiple firmware provider repositories 210-1, 210-2, and 210-3 from which customers can download source code through a customer portal. The customers can then modify these sources according to their platform requirements through various mechanisms implemented in the OxM repository 226.

The modification process involves several operations at the OxM repository 226. Customers can modify the core source files, incorporate their platform-specific porting files, integrate their proprietary Intellectual Property (IP) packages, and apply patches either from their own developments or selectively chosen from the firmware provider fixes. These modifications are consolidated in the OxM repository 226 for generating the platform specific ports and builds 228.

In a first scheme, the workflow requires significant manual intervention during the platform porting process. For instance, when creating platform-specific firmware, developers may need to manually create sensor map files using specialized tools such as the Platform Management Configuration Program (PMCP), implement extensions to the core code such as OEM extensions to Redfish code, and define appropriate kernel configurations based on the platform requirements. Additionally, developers may need to manually manage feature and library dependencies while constructing the build features and create specific recipes for firmware building.

After the initial build process, the firmware undergoes a sequential testing pipeline including the feature test 242, the platform test 246, the factory test 248 as described supra. Upon successful completion of all test phases, the firmware is distributed to both the deployment site 250 for implementation and the delivery portal 260 for distribution.

The build orchestration system interfaces with various tools and services through the cloud platform build orchestration service. This service coordinates the entire process from source code management to final deployment, though currently requiring manual oversight at multiple stages. The system supports both BIOS and BMC firmware development, with each type having its specific requirements and testing protocols within the pipeline structure.

The complexity of this manual process in the first scheme creates opportunities for optimization through automation and intelligent orchestration. The current system, while functional, requires significant human intervention at various stages, potentially introducing delays and inconsistencies in the firmware development and deployment pipeline.

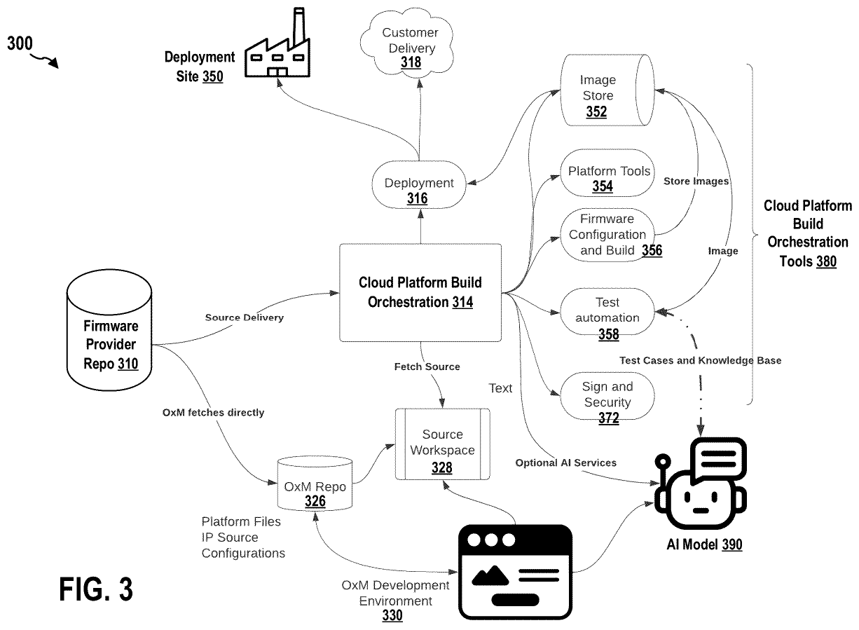

FIG. 3 is a diagram 300 illustrating a cloud-enabled firmware development and deployment architecture. A cloud platform build orchestration 314 is a central service that manages the end-to-end sequence of actions needed for firmware development, configuration, testing, and deployment. A firmware provider repository 310 delivers source code to the cloud platform build orchestration 314, which interacts with a source workspace 328 to integrate platform files, intellectual property source code, and other configurations provided by an OxM repository 326. The OxM development environment 330 allows a customer to adapt firmware code to specific platform needs, add custom features, and patch existing components. Once the modifications are ready, the cloud platform build orchestration 314 fetches all relevant sources from the workspace 328 and invokes a series of microservices that correspond to discrete steps in the pipeline.

In this example, these microservices are collectively represented by the cloud platform build orchestration tools 380, which include an image store 352, platform tools 354, firmware configuration and builds 356, test automation 358, and a sign and security component 372. The image store 352 retains built images and makes them available for validation or deployment. The platform tools 354 manage toolchains or utilities related to sensor mapping, Redfish extensions, and kernel configuration, etc. The firmware configuration and builds 356 section handles the process of compiling, linking, and packaging the firmware code. The test automation 358 component uses a knowledge base of test cases to validate each new firmware image and record diagnostic results. The sign and security component 372 applies cryptographic signing workflows and security policies to confirm that built images originate from trusted sources and remain tamper-free.

Once the build orchestration finishes, the deployment 316 process sends images to a deployment site 350, which may represent a factory or a data center. A customer delivery stage 318 then distributes the firmware images to customer environments.

An AI model 390 is an intelligence layer that interprets textual prompts related to the firmware pipeline. By analyzing prompts such as “Generate a BIOS image and produce a security report” from the cloud platform build orchestration 314, the AI model 390 can select the correct platform configuration, perform the firmware build, and produce an appropriate security artifact. The AI model 390 can also facilitate advanced prompts that address multiple steps at once, for example requesting a BMC image with added Redfish functionality, deploying it on a set of IP addresses, and invoking a test automation run. These prompts reduce manual overhead during platform porting and testing. Instead of following a rigid, pre-defined pipeline, developers can dynamically adjust the order of operations, request parallel builds of BIOS and BMC firmware, or modify platform configurations and automatically trigger performance tests on newly created images.

The features discussed in the earlier sections reflect the difficulties of managing platform-specific recipes, patching source code, and maintaining cohesive integration of new features across multiple firmware components. The cloud platform build orchestration 314 addresses the challenges discussed referring to FIG. 2 by unifying the build, test, and deployment phases into a single pipeline that works closely with the AI model 390. By reducing manual labor at each step, the pipeline accelerates firmware releases and improves the consistency of the final builds, as proposed in the invention disclosure. When certain steps fail or the firmware does not boot, the system evaluates the logs through an iterative process, allowing the AI model 390 to identify possible root causes and supply updated configuration or code generation artifacts. This approach may eliminate the frequent manual intervention that the first scheme required and brings a flexible mode of operation where the pipeline dynamically invokes the correct microservices based on natural language prompts.

In the example of FIG. 3, the cloud platform build orchestration 314 integrates with the AI model 390 to optimize the firmware development pipeline. When an ODM or OEM customer fetches sources from the firmware provider repository 310 to create platform code for BIOS, BMC, or hardware root of trust firmware, the system automates the creation of platform-specific configurations and files through the AI model 390.

The AI model 390 functions as a generative AI solution that processes natural language prompts to coordinate actions across the cloud platform build orchestration tools 380. For example, when a customer inputs a prompt requesting “Generate a BIOS image for an Intel platform and create a security report,” the AI model 390 analyzes the intent and orchestrates multiple sequential actions. It first selects appropriate platform configurations from the source workspace 328, triggers the firmware configuration and builds 356 to create the BIOS image, and then invokes the sign and security component 372 to generate the requested security report.

The system supports complex multi-step operations through single prompts. For instance, when processing a request to “Generate a BMC image with Redfish and GPU support and deploy to an IP range,” the AI model 390 coordinates with the platform tools 354 to configure Redfish extensions, manages the build process through the firmware configuration and builds 356, stores the resulting image in the image store 352, and orchestrates deployment 316 to the specified IP addresses at the deployment site 350.

The AI model 390 also enables dynamic modification of the build pipeline itself. Rather than following a fixed sequence, customers can request parallel builds of BIOS and BMC firmware, modify platform configurations, and automatically trigger comparative performance testing through the test automation 358. The test results and build logs flow back to the cloud platform build orchestration 314, where the AI model 390 can analyze failures, identify root causes, and suggest corrective actions or configuration updates.

This integration addresses the manual intervention challenges present in traditional firmware development workflows. The AI model 390 automates the generation of platform porting files, configuration files, and test code based on customer requirements. When an image build is completed, the system automatically performs basic deployment validation through the test automation 358 to verify fundamental functionality such as successful system boot. If issues are detected, the AI model 390 examines the test logs and diagnostic data to determine failure causes, enabling continuous improvement of the build process.

The cloud platform build orchestration 314 maintains coordination between the OxM development environment 330 and the various microservices represented by the cloud platform build orchestration tools 380. This creates a unified pipeline where the AI model 390 can dynamically sequence and invoke the appropriate tools based on natural language prompts, significantly reducing manual overhead in platform porting, testing, and deployment operations.

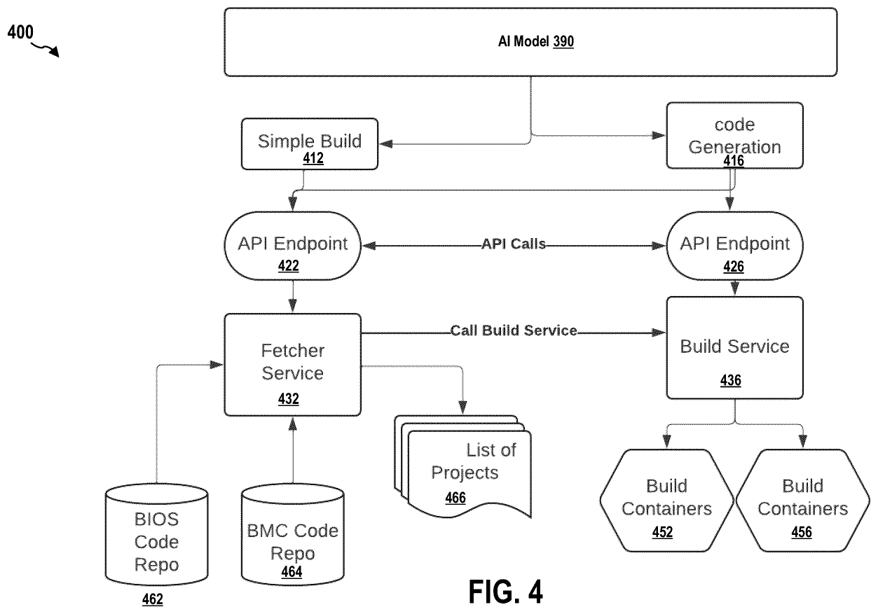

FIG. 4 is a diagram 400 illustrating a detailed view of the interaction between the AI model 390 and build services in the firmware development pipeline. The diagram shows how the AI model 390 interfaces with various components to facilitate both simple builds and code generation workflows.

In the architecture depicted in FIG. 4, the AI model 390 connects to two primary pathways: a simple build 412 and a code generation 416. These pathways represent different approaches to handling firmware build requests based on the complexity and requirements of the task. The simple build 412 pathway is utilized when direct firmware compilation is needed without additional code generation or complex manipulations. The code generation 416 pathway is employed when the system needs to generate platform-specific code or configurations based on user requirements.

Both pathways interface with their respective API endpoints—an API endpoint 422 for the simple build pathway and an API endpoint 426 for the code generation pathway. These API endpoints establish standardized interfaces for communication between the AI model 390 and the underlying services. The API endpoints exchange information through API calls, creating a structured communication framework that enables the dynamic orchestration of build processes.

A fetcher service 432 serves as a central component that coordinates with both the BIOS code repository 462 and the BMC code repository 464. The fetcher service 432 is responsible for retrieving the appropriate source code and configurations from these repositories based on the build requirements. The BIOS code repository 462 contains the firmware source code for basic input/output system implementations, while the BMC code repository 464 stores the baseboard management controller firmware source code.

The fetcher service 432 also connects with a list of projects 466, and maintains information about the firmware projects and their configurations. This component enables the system to track and organize multiple firmware development initiatives simultaneously. The fetcher service 432 communicates with a build service 436, which orchestrates the actual compilation and building of firmware images.

The build service 436 manages multiple build containers 452 and 456, which provide isolated environments for firmware compilation. These containers enable parallel processing of different build requests and maintain separation between various build configurations and dependencies. The containerized approach allows for consistent and reproducible build environments across different platforms and configurations.

The integration of these components creates a flexible and automated pipeline that supports both simple and complex firmware building scenarios. When a user submits a prompt to the AI model 390, the system analyzes the intent and automatically determines whether to utilize the simple build pathway or the code generation pathway. For example, when a user requests “Generate a BIOS image for my Intel platform based on Archer City and create a security report,” the AI model 390 can coordinate with the appropriate API endpoints to fetch the required code, initiate the build process, and generate the requested security documentation.

The API calls between the endpoints facilitate dynamic sequencing of operations. For instance, when a user requests “Build a BIOS image, then do a BMC image, flash the BMC image first and then flash the BIOS image,” the system can interpret this sequence and orchestrate the appropriate API calls to execute these operations in the specified order. This dynamic sequencing capability represents a significant advancement over traditional fixed pipeline approaches, allowing for flexible workflow customization based on natural language prompts.

As shown, the broader cloud platform build orchestration system shown in FIG. 3 enables automated firmware development workflows that reduce manual intervention while maintaining precise control over the build and deployment process.

As shown, a key feature of the system is the dynamic sequencing of API calls by the AI model 390. Upon receiving a complex prompt such as “Build a BIOS image, then build a BMC image, flash the BMC image first and then flash the BIOS image,” the AI model 390 determines the sequence of operations required and the corresponding API calls for each action. It first invokes the API calls to perform the BIOS build via the simple build pathway 412. Simultaneously or subsequently, it initiates the build of the BMC image, potentially utilizing the code generation pathway 416 if necessary.

Once both images are compiled, the AI model 390 generates API calls to the deployment services to flash the BMC image before the BIOS image, adhering to the user's specified sequence. This dynamic pipeline optimization allows developers to customize the build and deployment process without manual intervention, simply by providing high-level instructions through natural language prompts.

The microservices architecture of the cloud platform build orchestration tools 380 includes various services such as the fetcher service 432, the build service 436, deployment services, security signing services, software bill of materials (SBOM) generation, and report generation. Each service exposes APIs that the AI model 390 can invoke. As new services and APIs are developed and integrated into the system, the AI model 390 can access these functionalities, expanding the capabilities of the dynamic pipeline.

By integrating the AI model 390 with the microservices architecture, the system becomes highly extensible and adaptable. Developers can introduce new actions or modify existing ones by updating the AI model's understanding of available services and their corresponding APIs. The AI model 390 functions as a dynamic platform pipeline optimizer that continuously adapts to perform actions specified by the user, optimizing the sequence of API calls to achieve the desired outcomes.

Furthermore, the system supports the addition of specialized code repositories, such as the silicon root of trust code repository, which may contain code for particular technologies. The fetcher service 432 can retrieve code from these repositories when required, and the build service 436 can compile it within the appropriate build containers.

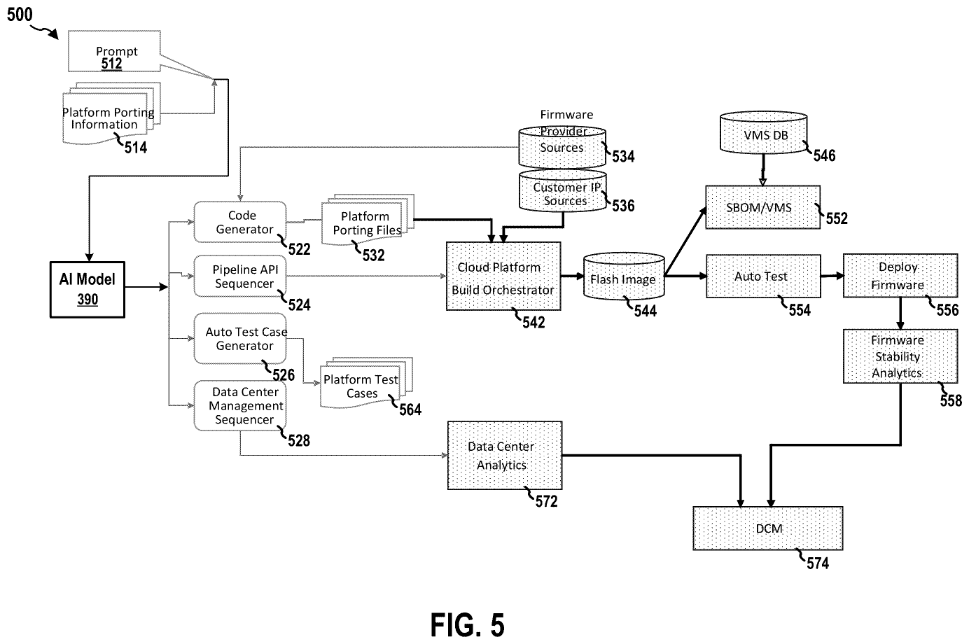

FIG. 5 is a diagram 500 illustrating an infrastructure management services architecture incorporating artificial intelligence for firmware development pipeline optimization. The diagram shows how the AI model 390 integrates with various components to create an intelligent firmware development and deployment workflow.

A prompt 512 and platform porting information 514 are first provided to the AI model 390, which interprets the request and interacts with a set of specialized modules that each perform different tasks in the pipeline. The AI model 390 communicates with a code generator 522, a pipeline API sequencer 524, an auto test case generator 526, and a data center management sequencer 528, forming an end-to-end orchestration system for creating, validating, and distributing firmware images.

The code generator 522 produces platform porting files 532 that reflect custom configurations and hardware requirements. These platform porting files 532 capture modifications needed for the target device, including platform-specific drivers, kernel-level definitions, and other configuration data. The pipeline API sequencer 524 coordinates with a cloud platform build orchestrator 542 to transform the platform porting files 532, along with firmware provider sources 534 and customer IP sources 536, into a compiled firmware image. This compiled product is stored as a flash image 544 that is subsequently passed through the remaining stages.

A VMS database 546 stores vulnerability information along with platform versions, which feeds into SBOM and VMS components 552 for creating a SBOM and vulnerability report for the constituent components and their versions. The system implements several validation and deployment stages, including an auto test procedure 554 and a firmware deployment procedure 556. A firmware stability analytics 558 component monitors the deployed firmware's performance and stability.

Once the flash image 544 is created, the auto test procedure 554 performs functional checks on the firmware to detect errors or inconsistencies. The VMS database 546 and the SBOM/VMS 552 work in conjunction to verify that the firmware image includes correct software components and that any dependencies are traceable. If the auto test procedure 554 completes without major issues, the firmware deployment procedure 556 is triggered, deploying the verified firmware to the intended systems. A firmware stability analytics 558 component monitors the deployed firmware in real time, identifying potential instabilities or bugs by collecting and analyzing system metrics and logs.

The auto test case generator 526 also supplies a set of platform test cases 564, which can be applied to the newly built firmware as part of the automated validation. Meanwhile, the data center management sequencer 528 gathers runtime feedback from the platform and combines it with information from the data center analytics 572 component. Insights from these analytics feed back into a DCM 574, closing the loop for performance tracking and platform health monitoring.

In this pipeline, each component communicates with the AI model 390 through a series of orchestrated API calls, allowing the prompt 512 to drive multiple tasks from code generation and image building to testing and deployment. The AI model 390 automatically interprets the context of the prompt, sequences the required microservices, and handles conditional tasks such as security checks, patch integrations, or performance evaluations. By integrating these steps into a single workflow, the cloud platform pipeline can dynamically generate and test firmware images based on high-level instructions, reducing manual overhead and bringing consistency to firmware development and delivery.

In the example of FIG. 5, the AI model 390 functions as an intelligent layer that interprets natural language prompts and coordinates multiple components to create an efficient firmware development workflow. The process begins when a user provides the prompt 512 and the platform porting information 514 to the AI model 390. The prompt 512 may include high-level instructions such as “Generate a BIOS image for my Intel platform and create a security report,” while the platform porting information 514 contains metadata and specific details about the target platform. The AI model 390 analyzes the prompt 512 and the platform porting information 514 to understand the user's intent and the specific requirements of the platform.

Upon interpreting the prompt, the AI model 390 interacts with several specialized modules to execute the required tasks. One of these modules is the code generator 522, which produces the platform porting files 532. The platform porting files 532 encapsulate custom configurations, platform-specific drivers, kernel settings, and other modifications necessary for the target device. By generating these files, the code generator 522 automates the creation of platform-specific artifacts that previously required manual intervention.

The pipeline API sequencer 524 acts as an intermediary between the AI model 390 and the cloud platform build orchestrator 542. The pipeline API sequencer 524 translates the analyzed intent from the prompt 512 into a sequence of API calls that invoke the appropriate microservices within the cloud platform build orchestrator 542. For instance, the pipeline API sequencer 524 may coordinate actions such as fetching source code from firmware provider sources 534 and customer IP sources 536, initiating the build process, running tests, and generating reports.

The cloud platform build orchestrator 542, in coordination with the pipeline API sequencer 524, compiles the firmware code using the platform porting files 532, firmware provider sources 534, and customer IP sources 536. The result is the flash image 544, which is a compiled firmware image ready for deployment.

To validate the generated firmware, the AI model 390 utilizes the auto test case generator 526. Based on the prompt 512, the platform porting information 514, and details of the target platform, the auto test case generator 526 produces the platform test cases 564. These test cases are designed to assess the specific features and configurations of the firmware for the target platform.

Once the flash image 544 is created, it undergoes testing through an auto test procedure 554. This procedure executes the platform test cases 564 to evaluate the firmware's functionality, performance, and stability. Test results, along with version management information from a VMS database 546 and software bill of materials from an SBOM/VMS component 552, are analyzed to determine the firmware's readiness for deployment.

After successful testing, the firmware deployment procedure 556 deploys the flash image 544 to the target systems. Post-deployment, the firmware stability analytics component 558 monitors the deployed firmware for any issues, collecting data on performance and reliability.

Furthermore, the AI model 390 interacts with a data center management sequencer 528. This module manages data center analytics 572 and communicates with a data center management (DCM) component 574. The data collected from deployed firmware installations is fed back into the system, enabling continuous improvement. Insights from the data center analytics 572 inform future firmware builds and configurations, supporting an iterative development process.

By integrating these components, the AI model 390 automates the firmware development pipeline. The AI model 390 interprets user prompts, generates necessary code and configurations, sequences API calls to orchestrate build and test processes, and manages deployment and analytics. This integration significantly reduces manual intervention, accelerates the development cycle, and enhances the consistency and quality of firmware releases.

The cloud platform build orchestration system implements an AI-driven approach to firmware development and deployment through natural language processing of user prompts. The AI model 390 serves as an intelligent interface that interprets complex instructions and coordinates multiple pipeline components to execute firmware development tasks.

The system supports various types of natural language prompts that trigger different sequences of operations. For example, when a user submits a prompt requesting “Generate a BIOS Image for my intel platform based on Archercity and create a security report,” the AI model 390 decomposes this instruction into multiple discrete operations. First, the AI model 390 instructs the pipeline API sequencer 524 to select the appropriate platform configuration from the platform porting files 532. Then, it coordinates with the cloud platform build orchestrator 542 to create the BIOS image using the firmware provider sources 534 and customer IP sources 536. Finally, it invokes the sign and security component 372 to generate the required security documentation.

More complex operations are demonstrated when processing prompts such as “Generate a BMC Image with Redfish and GPU support for my Nvidia platform and deploy the image on <ip-range>.” In this case, the AI model 390 orchestrates a sequence that begins with the code generator 522 creating platform-specific configurations for Redfish and GPU support. The pipeline API sequencer 524 then coordinates with the cloud platform build orchestrator 542 to compile the BMC image. Upon successful compilation, the firmware deployment procedure 556 automatically deploys the image to the specified IP addresses at the deployment site 350.

The system also supports comparative analysis through prompts like “Modify the platform configuration and then make two builds with older and new configuration and test the performance.” The AI model 390 coordinates with the auto test case generator 526 to create appropriate platform test cases 564 for performance comparison. The pipeline API sequencer 524 manages parallel builds using different configurations in the build containers 452 and 456, while the test automation 358 executes the performance tests and generates comparative reports.

The AI model 390 maintains state awareness across multiple operations, enabling commands such as “Run automatic test on all the images I have created in last build process and provide me a report.” This functionality requires the AI model 390 to track previous build operations through the VMS database 546 and coordinate with the auto test procedure 554 to execute comprehensive testing across multiple firmware images.

These prompt-driven interactions exemplify the adaptability gained by combining the cloud platform build orchestration 314 with the AI model 390. Instead of handling numerous manual steps, a user can describe the desired task once, triggering a chain of microservices that fetch source code, configure it for a specific platform, generate required security or patch artifacts, build the firmware, and initiate tests. If a specialized extension is needed (for example, adding an IPMI command post-processing hook), the user can request code through a prompt, and the AI model 390 can generate a relevant C implementation snippet that integrates into the underlying firmware codebase. The snippet below shows an example of adding a post-processing function for an IPMI command within PDK hooks, reflecting how the AI model 390 can automatically produce tailored code fragments:

```
  #include <stdio.h>
  // Function prototype for the post-processing function
  void postProcessIPMICommand(int commandCode, int responseCode);
  // PDK_PostMonitorSensor function
  int PDK_PostMonitorSensor(int SensorNum, int* pSensorReading, int*
pReadFlags) {
    int result = 0;
    // Perform post-processing based on the sensor reading
    if (*pSensorReading > 100) {
    // Set the response code to indicate an error
    *pReadFlags = - 1;
    // Call the post-processing function
    postProcessIPMICommand(0x1234, *pReadFlags);
    }
    // Continue with default handling
    return result;
}
```

This AI-driven approach represents a significant advancement over traditional CI/CD pipelines by eliminating the need for manual intervention at various stages of firmware development. The system intelligently sequences API calls based on natural language prompts, allowing platform developers to express complex build and test requirements in human-readable form. The AI model 390 then translates these requirements into appropriate sequences of operations across the cloud platform build orchestration tools 380.

The integration extends to post-deployment monitoring through the firmware stability analytics 558 and data center analytics 572 components. These analytics feed back into the AI model 390, enabling continuous improvement of the build and deployment process. The data center management sequencer 528 uses these insights to optimize future firmware configurations and deployment strategies.

Through this intelligent orchestration, the system reduces the complexity of firmware development while maintaining precise control over the build pipeline. Platform developers can focus on expressing their requirements through natural language prompts, while the AI model 390 handles the intricate details of coordinating multiple services and ensuring correct execution of the firmware development workflow.

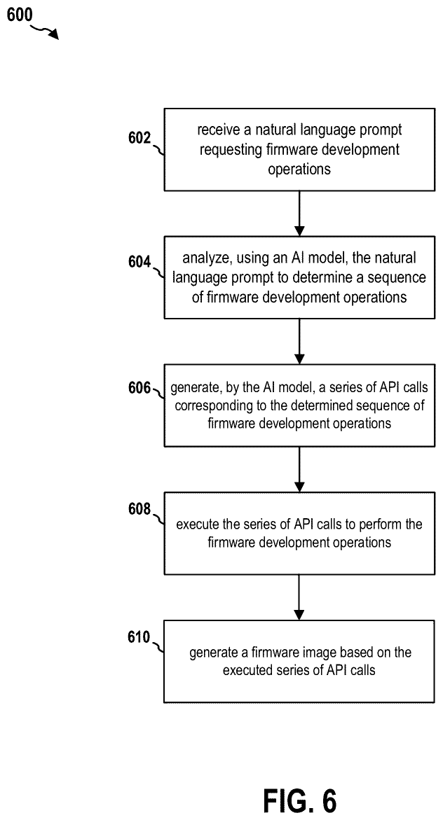

FIG. 6 is a flow chart 600 of a method for performing firmware development operations using artificial intelligence. The method may be performed by one or more computing devices (e.g., the cloud platform build orchestration system shown in FIG. 3). In operation 602, the one or more computing devices receive a natural language prompt requesting firmware development operations. In operation 604, the one or more computing devices analyze, using an artificial intelligence (AI) model, the natural language prompt to determine a sequence of firmware development operations. In operation 606, the one or more computing devices generate, by the AI model, a series of API calls corresponding to the determined sequence of firmware development operations. In operation 608, the one or more computing devices execute the series of API calls to perform the firmware development operations. In operation 610, the one or more computing devices generate a firmware image based on the executed series of API calls.

The one or more computing devices receive platform porting information associated with a target platform. The one or more computing devices generate, using a code generator, platform porting files based on the platform porting information. The one or more computing devices compile the firmware image using the platform porting files and firmware source code.

To execute the series of API calls, the one or more computing devices retrieve source code from one or more firmware provider repositories, retrieve platform-specific modifications from an original equipment manufacturer (OEM) repository, and consolidate the retrieved source code and platform-specific modifications in a source workspace.

The one or more computing devices generate, using an auto test case generator, platform test cases based on the natural language prompt. The one or more computing devices execute an automated test procedure using the generated platform test cases and analyze test results to validate the firmware image. The one or more computing devices monitor stability of the firmware image after deployment using firmware stability analytics, collect runtime data using data center analytics, and provide the collected runtime data to the AI model for improving future firmware development operations.

In certain configurations, the natural language prompt comprises a request to generate and deploy multiple firmware images. To execute the series of API calls, the one or more computing devices generate a first firmware image of a first type, generate a second firmware image of a second type, and deploy the first and second firmware images in a specified sequence.

The one or more computing devices maintain, in a version management system (VMS) database, version information for generated firmware images. The one or more computing devices generate a software bill of materials (SBOM) for the firmware image and validate the firmware image using the version information and SBOM.

To execute the series of API calls, the one or more computing devices instantiate one or more build containers, execute build operations for the firmware image within the one or more build containers, and store the firmware image in an image store.

The one or more computing devices analyze, using the AI model, build logs and test results when a firmware development operation fails, identify potential root causes of the failure, and generate updated configuration or code generation artifacts to address the identified root causes.

In certain configurations, the natural language prompt includes a request to perform comparative testing. To execute the series of API calls, the one or more computing devices generate a first firmware build using a first configuration, generate a second firmware build using a second configuration, execute performance tests on both firmware builds, and generate a comparative analysis report.

The one or more computing devices generate platform-specific code snippets based on the natural language prompt, integrate the generated code snippets into a firmware codebase, and validate functionality of the integrated code snippets during firmware compilation.

To execute the series of API calls, the one or more computing devices coordinate with a fetcher service to retrieve appropriate source code from multiple code repositories, manage dependencies between different firmware components, and orchestrate parallel build operations across multiple build containers.

The one or more computing devices generate security documentation for the firmware image, apply cryptographic signing to the firmware image, and validate the signed firmware image against security policies.

In certain configurations, the natural language prompt comprises a request to modify an existing firmware configuration. To execute the series of API calls, the one or more computing devices retrieve an existing firmware configuration, generate modified platform porting files based on requested modifications, build a new firmware image using the modified platform porting files, and execute comparison tests between the existing firmware configuration and the new firmware image.

The one or more computing devices monitor deployment of the firmware image across specified IP addresses, collect performance metrics from deployed firmware instances, and analyze the collected metrics to optimize future firmware configurations.

In certain configurations, the firmware development operations is performed using a cloud platform build orchestration service.

The computing devices in FIGS. 2-6, which illustrate various aspects of the firmware development and deployment pipeline, can be implemented using the computer system 100 shown in FIG. 1. Specifically, the host computer 180, comprising the host CPU 182, host memory 184, storage devices 185, and component devices 186-1 to 186-N, can serve as the hardware platform for executing the software components and services described in the subsequent figures. For instance, the cloud platform build orchestration 314 in FIG. 3, along with its associated tools 380 and AI model 390, can run on the host computer 180, utilizing its processing power, memory, and storage capabilities to manage the firmware development workflow. Similarly, the repositories, build services, and API endpoints shown in FIG. 4, as well as the AI-driven infrastructure management services in FIG. 5, can be hosted on the host computer 180, leveraging its resources to perform the required computations and operations.

Furthermore, the baseboard management controller (BMC) 102 depicted in FIG. 1 can play a role in managing and monitoring the firmware deployed on the host computer 180. The BMC 102, with its main processor 112, memory 114, and various interfaces, can interact with the host computer 180 through the IPMI interface, facilitating remote access, system management, and monitoring of the deployed firmware. The service components 132 within the BMC firmware code and data 106, including IPMI services 134 and system management component 136, can work in conjunction with the AI model 390 and cloud platform build orchestration 314 to provide a comprehensive solution for firmware development, deployment, and management. The communication network 170 and data network 172 can facilitate communication between the host computer 180, BMC 102, and remote devices, enabling remote management and data exchange for the firmware pipeline.

The AI model 390 may be a Large Language Model (LLM) specifically trained on firmware development domain knowledge, platform configurations, and API specifications. The LLM may be fine-tuned on specialized datasets including firmware source code, platform porting documentation, build configurations, test cases, and deployment patterns to understand the technical context and requirements of firmware development workflows. This model may have components for: (1) natural language understanding to parse user prompts and extract intended operations, (2) a context management system to maintain state across multiple operations and track build histories, (3) a task planning module to decompose complex firmware development requests into sequences of atomic operations, and (4) an API orchestration layer to translate high-level intents into specific sequences of microservice API calls.

The AI model 390 can make informed decisions about platform-specific requirements and generate accurate code snippets or configurations. The model may incorporate a feedback loop mechanism that learns from the firmware stability analytics 558 and data center analytics 572 to continuously improve its decision-making process for future firmware development tasks. The model understands both the technical domain and the contextual relationships between different components of the firmware development pipeline.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
receiving a natural language prompt requesting firmware development operations;
analyzing, using an artificial intelligence (AI) model, the natural language prompt to determine a sequence of firmware development operations;
generating, by the AI model, a series of API calls corresponding to the determined sequence of firmware development operations;
executing the series of API calls to perform the firmware development operations; and
generating a firmware image based on the executed series of API calls.

2. The method of claim 1, further comprising:
receiving platform porting information associated with a target platform;
generating, using a code generator, platform porting files based on the platform porting information; and
compiling the firmware image using the platform porting files and firmware source code.

3. The method of claim 1, wherein executing the series of API calls comprises:
retrieving source code from one or more firmware provider repositories;
retrieving platform-specific modifications from an original equipment manufacturer (OEM) repository; and
consolidating the retrieved source code and platform-specific modifications in a source workspace.

4. The method of claim 1, further comprising:
generating, using an auto test case generator, platform test cases based on the natural language prompt;
executing an automated test procedure using the generated platform test cases; and
analyzing test results to validate the firmware image.

5. The method of claim 4, further comprising:
monitoring stability of the firmware image after deployment using firmware stability analytics;
collecting runtime data using data center analytics; and
providing the collected runtime data to the AI model for improving future firmware development operations.

6. The method of claim 1, wherein the natural language prompt comprises a request to generate and deploy multiple firmware images, and wherein executing the series of API calls comprises:
generating a first firmware image of a first type;
generating a second firmware image of a second type; and
deploying the first and second firmware images in a specified sequence.

7. The method of claim 1, further comprising:
maintaining, in a version management system (VMS) database, version information and vulnerability information for generated firmware images;
generating a software bill of materials (SBOM) for the firmware image; and
validating the firmware image using the version information and SBOM.

8. The method of claim 1, wherein executing the series of API calls comprises:
instantiating one or more build containers;
executing build operations for the firmware image within the one or more build containers; and
storing the firmware image in an image store.

9. The method of claim 1, further comprising:
analyzing, using the AI model, build logs and test results when a firmware development operation fails;
identifying potential root causes of the failure; and
generating updated configuration or code generation artifacts to address the identified root causes.

10. The method of claim 1, wherein the natural language prompt includes a request to perform comparative testing, and wherein executing the series of API calls comprises:
generating a first firmware build using a first configuration;
generating a second firmware build using a second configuration;
executing performance tests on both firmware builds; and
generating a comparative analysis report.

11. The method of claim 1, further comprising:
generating platform-specific code snippets based on the natural language prompt;
integrating the generated code snippets into a firmware codebase; and
validating functionality of the integrated code snippets during firmware compilation.

12. The method of claim 1, wherein executing the series of API calls comprises:
coordinating with a fetcher service to retrieve appropriate source code from multiple code repositories;
managing dependencies between different firmware components; and
orchestrating parallel build operations across multiple build containers.

13. The method of claim 1, further comprising:
generating security documentation for the firmware image;
applying cryptographic signing to the firmware image; and
validating the signed firmware image against security policies.

14. The method of claim 1, wherein the natural language prompt comprises a request to modify an existing firmware configuration, and wherein executing the series of API calls comprises:
retrieving an existing firmware configuration;
generating modified platform porting files based on requested modifications;
building a new firmware image using the modified platform porting files; and
executing comparison tests between the existing firmware configuration and the new firmware image.

15. The method of claim 1, further comprising:
monitoring deployment of the firmware image across specified IP addresses;
collecting performance metrics from deployed firmware instances; and
analyzing the collected metrics to optimize future firmware configurations.

16. The method of claim 1, wherein the firmware development operations is performed using a cloud platform build orchestration service

17. A system, including one or more computing devices, comprising:
a memory; and
at least one processor coupled to the memory and configured to:
receive a natural language prompt requesting firmware development operations;
analyze, using an artificial intelligence (AI) model, the natural language prompt to determine a sequence of firmware development operations;
generate, by the AI model, a series of API calls corresponding to the determined sequence of firmware development operations;
execute the series of API calls to perform the firmware development operations; and
generate a firmware image based on the executed series of API calls.

18. The system of claim 17, wherein the at least one processor is further configured to:
receive platform porting information associated with a target platform;
generate, using a code generator, platform porting files based on the platform porting information; and
compile the firmware image using the platform porting files and firmware source code.

19. The system of claim 17, wherein to execute the series of API calls, the at least one processor is configured to:
retrieve source code from one or more firmware provider repositories;
retrieve platform-specific modifications from an original equipment manufacturer (OEM) repository; and
consolidate the retrieved source code and platform-specific modifications in a source workspace.

20. A non-transitory computer-readable medium storing computer executable code for operating one or more computing devices, comprising code to:
receive a natural language prompt requesting firmware development operations;
analyze, using an artificial intelligence (AI) model, the natural language prompt to determine a sequence of firmware development operations;
generate, by the AI model, a series of API calls corresponding to the determined sequence of firmware development operations;
execute the series of API calls to perform the firmware development operations; and
generate a firmware image based on the executed series of API calls.
